(19) United States
(12) Patent Application Publication
(10) Pub. No.: US 2021/0270569 A1
(43) Pub. Date: Sep. 2, 2021

(54) FIREARM SIMULATION ARRANGEMENT FOR A VIRTUAL REALITY SYSTEM

(71) Applicant: DREAMSCAPE IMMERSIVE, INC., Culver City, CA (US)

(72) Inventor: Christopher Purvis, Los Angeles, CA (US)

(21) Appl. No.: 17/257,515

(22) PCT Filed: Jun. 27, 2019
(86) PCT No.: PCT/IB2019/055470

§ 371 Date: Dec. 31, 2020

Related U.S. Application Data
(60) Provisional application No. 62/693,041, filed on Jul. 2, 2018.

(51) Int. Cl. F41G 3/26

(52) U.S. Cl. CPC F41G 3/26; G06F 3/014

(57) ABSTRACT

A firearm simulation arrangement for a virtual reality system, includes a firearm having a trigger mechanism actuating a firing mechanism for firing ammunition. The firearm, the ammunition, and a user extremity arranged to hold the firearm each have a unique indicium. A detection arrangement detects the unique indicia, identifies and tracks the firearm, ammunition, or user extremity, and forms a tracking signal in response. A controller device in communication with a user-worn virtual reality headset, is arranged to receive the tracking signal from the detection arrangement and determine therefrom a discharge of the ammunition by the firing mechanism associated with the tracking of the firearm, ammunition, or user extremity. The controller device is responsive to the discharge determination to display on the virtual reality headset a virtual simulation of the firearm discharging the ammunition upon actuation of the trigger mechanism by the user extremity. An associated arrangement is also provided.

### BACKGROUND OF THE DISCLOSURE

### Field of the Disclosure

Aspects of the disclosure are directed to virtual reality systems and, more particularly, to an arrangement for simulating discharge of a firearm or other handheld weapon in a virtual reality system.

### Description of Related Art

Simulated firearm (or other weapons) training which leverages virtual environments offers several advantages to real-world, live fire training. That is, in one aspect, simulated firearm training offers a substantially lower risk of injury or death to the participants as the environment is totally controlled, and likely no actual ordinance, projectiles, or similarly hazardous materials are involved. Simulated training also allows flexibility of locations, repeatable test scenarios, and significantly lower costs, as compared to conducting live fire exercises that simulate combat conditions. However, one disadvantage to simulated weapons training systems, as compared to live training, is the degree of realism experienced by the user.

Simulated weapons training in a virtual reality environment typically involves simulated weaponry, with computer-generated, simulated responses of that weaponry being experienced by the trainee. The visceral response of firing a real firearm or weapon, using real cartridges or ammunition, or reloading with realistic ammunition is not typically part of a virtual reality-based weapons training simulation. Further, the weapon stand-ins or props used in a typical virtual reality simulation are often physically tethered to a computer disposed either on the user's person or somewhere nearby. This physically-tethered prop arrangement, however, may often limit the user's freedom of movement, the ability of the user to drop the weapon, and does not provide the user a solution for switching between multiple weapons, at least not between multiple physical weapon proxies (props), while the virtual reality simulation is running. When multiple users/participants are present in the same simulated virtual reality training environment, typical solutions do not allow those users/participants to exchange weapons, or for one user to pick up and handle a weapon discarded by another participant.

Thus, there exists a need in a virtual environment for the capability of incorporating real firearms or weaponry into a virtual reality based training simulation, wherein such firearms/weapons are not physically tethered to the user(s), and wherein the arrangement allows for realistic weapon performance and behavior to be experienced by the user, such that the user-experience is near indistinguishable from the user using a firearm to fire live ammunition in the field. Desirably, the untethered firearms/weapons can be picked up, put down, exchanged, reloaded, or otherwise handled by the user(s) with the same freedom that the user(s) could handle such firearms/weapons in the real world.

### BRIEF SUMMARY OF THE DISCLOSURE

The above and other needs are met by the present disclosure which, in one aspect, provides a firearm simulation arrangement for a virtual reality system, comprising a firearm having a trigger mechanism engaged with a firing mechanism configured to fire ammunition. A unique indicium is associated with each of the firearm, the ammunition, and a user extremity arranged to hold the firearm. A detection arrangement is configured to detect the unique indicia and to identify and track the firearm, the ammunition, or the user extremity, and form a tracking signal in response thereto. A controller device is engaged with the detection arrangement and is in communication with a virtual reality headset adapted to be worn by the user. The controller device is arranged to receive the tracking signal from the detection arrangement and determine therefrom a discharge of the ammunition by the firing mechanism associated with the tracking of the firearm, the ammunition, or the user extremity. The controller device is responsive to the discharge determination to display on the virtual reality headset a virtual simulation of the identified firearm discharging the identified ammunition upon actuation of the trigger mechanism by the identified user extremity.

Another aspect of the present disclosure provides a firearm simulation arrangement for a virtual reality system. Such an arrangement includes a firearm having a trigger mechanism engaged with a firing mechanism configured to fire ammunition, with each of the firearm and the ammunition having a unique indicium associated therewith. A detection arrangement is configured to detect the unique indicia and identify the firearm and the ammunition. A transmitter device is configured to communicate with the detection arrangement. A sensor device is configured to be in communication with the transmitter device and is associated with a user holding the firearm, wherein the sensor device is configured to be responsive to discharging of the ammunition by the firing mechanism to direct a firearm discharge signal through the transmitter device to the detection arrangement. A controller device is engaged with the detection arrangement and is in communication with a virtual reality headset adapted to be worn by the user. The controller device is responsive to the firearm discharge signal received from the sensor device to display on the virtual reality headset a virtual simulation of the identified firearm discharging the identified ammunition.

The present disclosure thus includes, without limitation, the following embodiments:

Embodiment 1: A firearm simulation arrangement for a virtual reality system, comprising a firearm having a trigger mechanism engaged with a firing mechanism configured to fire ammunition; a unique indicium associated with each of the firearm, the ammunition, and a user extremity arranged to hold the firearm; a detection arrangement configured to detect the unique indicia and to identify and track the firearm, the ammunition, or the user extremity, and form a tracking signal in response thereto; and a controller device engaged with the detection arrangement and being in communication with a virtual reality headset adapted to be worn by the user, the controller device being arranged to receive the tracking signal from the detection arrangement and determine therefrom a discharge of the ammunition by the firing mechanism associated with the tracking of the firearm, the ammunition, or the user extremity, the controller device being responsive to the discharge determination to display on the virtual reality headset a virtual simulation of the identified firearm discharging the identified ammunition upon actuation of the trigger mechanism by the identified user extremity.

Embodiment 2: The method of any preceding embodiment, or any combination of preceding embodiments, wherein the ammunition comprises a blank cartridge.

Embodiment 3: The method of any preceding embodiment, or any combination of preceding embodiments, wherein the controller device is configured to associate a virtual bullet with the blank cartridge, and to display the virtual bullet in the virtual simulation on the virtual reality headset.

Embodiment 4: The method of any preceding embodiment, or any combination of preceding embodiments, wherein the unique indicium associated with each of the firearm and the ammunition is configured to identify a position or an orientation of the firearm or ammunition, and the unique indicium associated with the user extremity is arranged to identify a position or an orientation of the user extremity in relation to the position or the orientation of the firearm or ammunition.

Embodiment 5: The method of any preceding embodiment, or any combination of preceding embodiments, wherein the controller device is responsive to the discharge determination to display on the virtual reality headset a virtual simulation of the user actuating the trigger mechanism of the identified firearm.

Embodiment 6: The method of any preceding embodiment, or any combination of preceding embodiments, wherein the controller device is responsive to the discharge determination to display on the virtual reality headset a trajectory of a virtual bullet launched from the discharged identified ammunition, based at least on a position or orientation of the identified firearm upon the discharge determination.

Embodiment 7: A firearm simulation arrangement for a virtual reality system, comprising a firearm having a trigger mechanism engaged with a firing mechanism configured to fire ammunition, each of the firearm and the ammunition having a unique indicium associated therewith; a detection arrangement configured to detect the unique indicia and identify the firearm and the ammunition; a transmitter device configured to communicate with the detection arrangement; a sensor device configured to be in communication with the transmitter device and being associated with a user holding the firearm, the sensor device being configured to be responsive to discharging of the ammunition by the firing mechanism, to direct a firearm discharge signal through the transmitter device to the detection arrangement; and a controller device engaged with the detection arrangement and being in communication with a virtual reality headset adapted to be worn by the user, the controller device being responsive to the firearm discharge signal received from the sensor device to display on the virtual reality headset a virtual simulation of the identified firearm discharging the identified ammunition.

Embodiment 8: The method of any preceding embodiment, or any combination of preceding embodiments, wherein the sensor device is selected from the group consisting of an inertial sensor, a motion sensor, an accelerometer, a rotation sensor, a gyroscope, a magnetic sensor, a magnetometer, a microphone, or combinations thereof.

Embodiment 9: The method of any preceding embodiment, or any combination of preceding embodiments, wherein the ammunition comprises a blank cartridge.

Embodiment 10: The method of any preceding embodiment, or any combination of preceding embodiments, wherein the controller device is configured to associate a virtual bullet with the blank cartridge, and to display the virtual bullet in the virtual simulation on the virtual reality headset.

Embodiment 11: The method of any preceding embodiment, or any combination of preceding embodiments, wherein the sensor device is engaged with a glove adapted to be worn on a trigger hand of the user or with the firearm.

Embodiment 12: The method of any preceding embodiment, or any combination of preceding embodiments, wherein the transmitter device is engaged with the glove.

Embodiment 13: The method of any preceding embodiment, or any combination of preceding embodiments, wherein the unique indicium associated with each of the firearm and the ammunition is configured to identify a position or an orientation of the firearm or ammunition.

Embodiment 14: The method of any preceding embodiment, or any combination of preceding embodiments, wherein the sensor device is configured to be responsive to acceleration of the firearm caused by the discharge of the ammunition to generate the firearm discharge signal.

Embodiment 15: The method of any preceding embodiment, or any combination of preceding embodiments, wherein the sensor device is configured to not generate the firearm discharge signal upon handling of the firearm occurring without discharging the ammunition.

Embodiment 16: The method of any preceding embodiment, or any combination of preceding embodiments, wherein the controller device is responsive to the firearm discharge signal received from the sensor device to display on the virtual reality headset a virtual simulation of the user actuating the trigger mechanism of the identified firearm.

Embodiment 17: The method of any preceding embodiment, or any combination of preceding embodiments, wherein the controller device is responsive to the firearm discharge signal received from the sensor device to display on the virtual reality headset a trajectory of a virtual bullet launched from the discharged identified ammunition, based at least on a position or orientation of the identified firearm upon receipt of the firearm discharge signal.

These and other features, aspects, and advantages of the present disclosure will be apparent from a reading of the following detailed description together with the accompanying drawings, which are briefly described below. The present disclosure includes any combination of two, three, four, or more features or elements set forth in this disclosure or recited in any one or more of the claims, regardless of whether such features or elements are expressly combined or otherwise recited in a specific aspect description or claim herein. This disclosure is intended to be read holistically such that any separable features or elements of the disclosure, in any of its aspects, should be viewed as intended to be combinable, unless the context of the disclosure clearly dictates otherwise.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 schematically illustrates a firearm simulation arrangement for a virtual reality system, according to one aspect of the present disclosure;

FIGS. 2A and 2B schematically illustrates an example firearm implemented in the firearm simulation arrangement shown in FIG. 1; and

FIG. 3 schematically illustrates an example of a firearm discharge signal produced by a sensor device associated with a firearm discharge, according to the firearm simulation arrangement shown in FIG. 1; and

FIG. 4 schematically illustrates a trajectory of a bullet based at least partially on the orientation of the firearm upon discharging a cartridge, according to the firearm simulation arrangement shown in FIG. 1.

### DETAILED DESCRIPTION OF THE DISCLOSURE

The present disclosure now will be described more fully hereinafter with reference to the accompanying drawings, in which some, but not all aspects of the disclosure are shown. Indeed, this disclosure may be embodied in many different forms and should not be construed as limited to the aspects set forth herein; rather, these aspects are provided so that this disclosure will satisfy applicable legal requirements. Like numbers refer to like elements throughout.

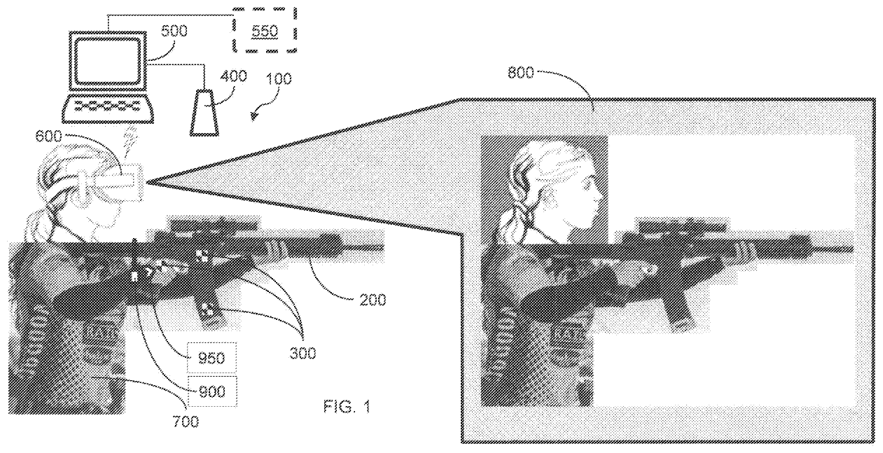

FIG. 1 schematically illustrates a firearm simulation arrangement for a virtual reality system, according to one aspect of the present disclosure, the arrangement being generally indicated by the numeral 100. As disclosed, the firearm simulation arrangement 100 is configured to facilitate a virtual environment having the capability of incorporating real firearms or weaponry into a virtual reality based training simulation. Preferably, the firearms/weapons facilitating the virtual reality based training simulation are not physically tethered to the user(s). Moreover, the arrangement 100 allows for realistic weapon performance and behavior to be experienced by the user, such that the user-experience is near indistinguishable from the user using a firearm to fire live ammunition in the field, wherein the untethered firearms/weapons can be picked up, put down, exchanged, reloaded, or otherwise handled by the user(s) with the same freedom that the user(s) could handle such firearms/weapons in the real world.

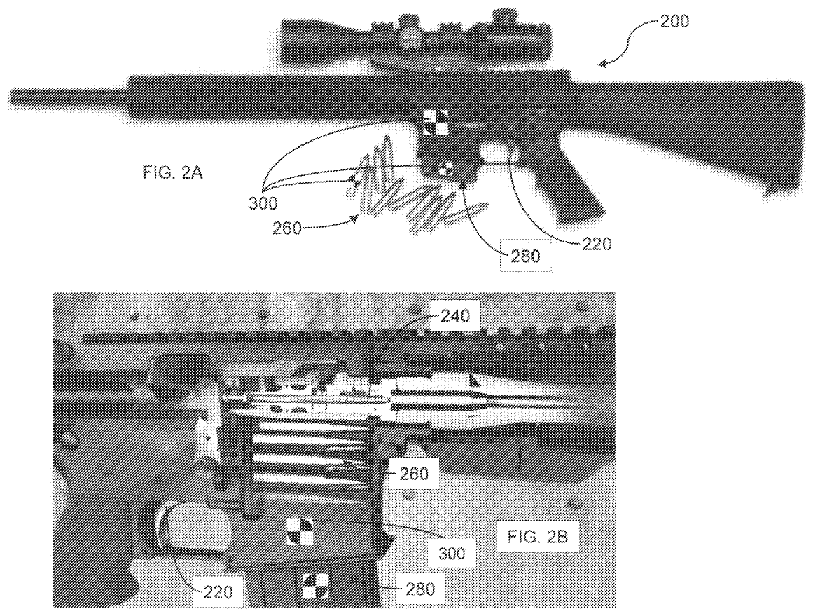

In one aspect, the arrangement 100 includes a firearm 200 (see, e.g., FIGS. 2A and 2B) having a trigger mechanism 220 engaged with a firing mechanism 240 configured to fire a particular ammunition 260, loaded into the firing chamber of the firearm 200 from an ammunition magazine 280. In such an aspect, the particular ammunition 260 may comprise a cartridge of any caliber, and is preferably a blank cartridge that includes a primer and a propellant (e.g., gunpowder), but may or not include a paper or plastic wadding to maintain the propellant within the cartridge, in place of a bullet or other projectile. That is, the blank cartridge is preferably configured to, upon firing, produce a flash, and explosive report, and otherwise shock/vibration associated with the firing of the wadding, instead of a bullet or projectile. In this manner, when fired in an actual firearm, the blank cartridge causes the firearm to react or respond in a similar manner (e.g., recoil) to that firearm firing conventional ammunition that includes a bullet or projectile launched by the firing of the primer/propellant elements of the cartridge. The reaction or response of the firearm to the firing of a cartridge, whether firing a blank cartridge or live ammunition, is distinct from other handling of the firearm. Such other handling includes for example, picking up, putting down or dropping, or exchanging the firearm, or loading, unloading or reloading ammunition with respect to the firearm. The firearm 200 having blank cartridges loaded therein will thus exhibit the handling and firing characteristics of a conventional firearm firing conventional live ammunition, from the weight and balance of the firearm itself, to the recoil characteristics, to the loading, unloading, and reloading of ammunition with respect to the firearm 200 and/or the magazine 280.

In order to identify and/or track the firearm 200, ammunition 260, and/or magazine 280, each of the firearm 200, ammunition 260, and/or magazine 280 may have a unique indicium 300 associated therewith. The indicium 300 may comprise, for example, a reflective marker, a fiducial marker, or other identifying element that can be tracked by a detection arrangement 400 in communication with a computer device 500 associated with the virtual reality system, wherein such tracking may indicate, for instance, the position and orientation of each of the firearm 200, ammunition 260, and/or magazine 280. That is, the detection arrangement 400 is configured to detect the unique indicium 300 associated with each of the firearm 200, ammunition 260, and/or magazine 280, and to identify and/or track the firearm, ammunition, and/or magazine in cooperation with the computer device 500 associated with the virtual reality system. For example, the unique indicium 300 associated with each of the firearm 200, ammunition 260, and/or magazine 280 and detected by the detection arrangement 400 may be identified by the computer device 500 as an AR-10 rifle using .308 Winchester ammunition in a 20 round magazine.

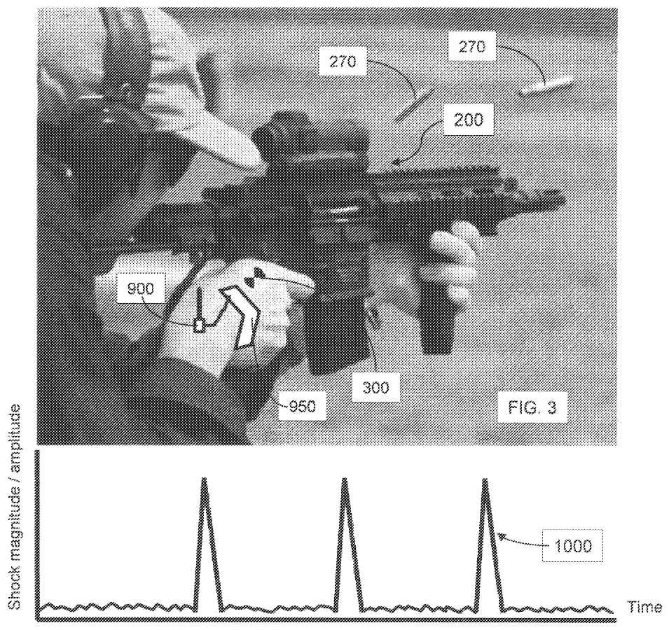

In a similar manner, a unique indicium 300 may also be associated with an extremity of the user (e.g., the user's hand, arm, or wrist), as shown, for example, in FIGS. 1 and 3, particularly the user extremity holding or engaging the firearm 200 and actuating the trigger mechanism 220. The detection arrangement 400 can thus also be configured to detect, identify, and/or track the user extremity, independently or in relation to the firearm 200, ammunition 260, and/or magazine 280, in cooperation with the computer device 500 associated with the virtual reality system. For example, the position, orientation, acceleration, rate of motion, and/or the like of the user extremity may be independently indicated by the tracking function, or may be indicated relative to the position, orientation, acceleration, rate of motion, and/or the like of any or all of the firearm 200, ammunition 260, and/or magazine 280.

In some aspects, the virtual reality system includes a controller device 550 engaged with the detection arrangement 400 and in communication with a virtual reality headset 600 adapted to be worn by a user 700. The controller device 550 may be separate and discrete component of the virtual reality system from the computer device 500 or, in some instances, may be integrated into the computer device 500, itself. In any instance, the controller device 550 may be configured so as to be in communication with the detection arrangement 400. Moreover, the controller device 550 is configured to be in communication with the virtual reality headset 600 and to direct a virtual scene or space 800 to be displayed on one or more displays associated with the virtual reality headset 600 so as to be visible to the user (wearer) 700.

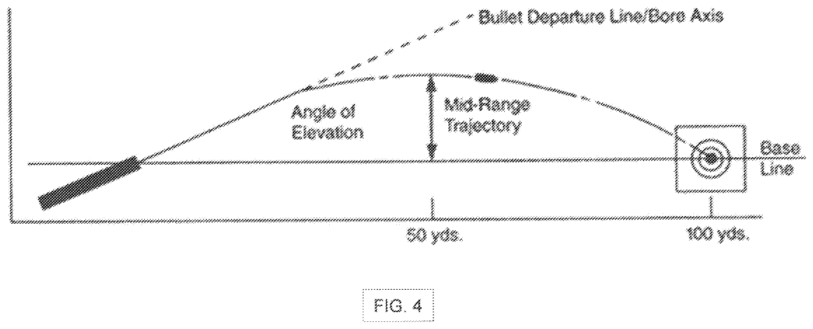

In one aspect of the present disclosure, the detection arrangement 400 is configured and arranged to detect, identify, and/or track the unique indicia associated with the firearm 200, ammunition 260, magazine 280, and/or the user extremity, and to form a tracking signal in response thereto. The controller device 550/computer device 500 engaged and in communication with the detection arrangement 400, is arranged to receive the tracking signal from the detection arrangement 400. By way of tracking the unique indicium 300 associated with at least the user extremity or at least the firearm 200, the controller device 550/computer device 500 is also configured to determine a discharge of the ammunition 260 by the firing mechanism 240 from the tracking signal. Such a discharge determination by the controller device 550/computer device 500 may be associated with or based on the tracking of the position, orientation, acceleration, rate of motion, and/or the like of the firearm 200, the ammunition 260, and/or the user extremity (see, e.g., FIG. 4). Once discharge of the ammunition 260 from the firearm 200 is determined by the controller device 550/computer device 500, the controller device 550/computer device 500 is responsive to or actuated by the discharge determination to direct a virtual simulation of the identified firearm 200 discharging the identified ammunition 260 upon actuation of the trigger mechanism 220 by the identified user extremity, to be displayed on the virtual reality headset 600. That is, the controller device 550/computer device 500 is configured and arranged to be in communication with the virtual reality headset 600 and to direct a virtual scene or space 800, including the identified firearm 200 discharging the identified ammunition 260 upon actuation of the trigger mechanism 220 by the identified user extremity, to be displayed on one or more displays associated with the virtual reality headset 600 so as to be visible to the user (wearer) 700.

In another aspect of the present disclosure, the firearm simulation arrangement 100 may include a transmitter device 900 configured to be in communication with the detection arrangement 400. In other aspects, the transmitter device 900 may be in communication with the computer device 500 and/or the controller device 550, instead of or in addition to the detection arrangement 400. A sensor device 950 (e.g., an inertial sensor, a motion sensor such as an accelerometer, a rotation sensor such as a gyroscope, a magnetic sensor such as a magnetometer, a microphone, or other sensor capable of detecting the discharge of a firearm, such as a suitable shock or vibration detection device) is configured to be in communication with the transmitter device 900 and is further associated with the user 700 holding the firearm 200. The sensor device 950 is configured to be responsive to discharging of the ammunition 260 by the firing mechanism 240, to direct a firearm discharge signal (see, e.g., element 1000 in FIG. 3) through the transmitter device 900 to the detection arrangement 400 (and/or directly to the computer device 500 and/or the controller device 550). The controller device 550 is configured to be responsive to the firearm discharge signal 1000 received from the sensor device 950 to display on the virtual reality headset 600 a virtual simulation, scene, or space 800 of the identified firearm 200 discharging the identified ammunition 260 (see, e.g., FIG. 1).

In some aspects of the disclosure, the sensor device 950 is engaged with a glove (not shown) adapted to be worn on a trigger hand of the user 700. The sensor device 950 may, in other instances, be engaged with the firearm 200, itself. One skilled in the art will appreciate, however, that the sensor device 950 may otherwise be engaged with the user 700 and/or the firearm 200, or between the user and the firearm 200, as appropriate, to as to be arranged to capture the shock/vibration, acceleration, and/or the like imparted to the user 700 and/or the firearm 200 by discharging of the ammunition round. As shown in FIG. 3, the sensor device 950 may be configured or arranged so as to be capable of distinguishing between the firearm 200 discharging ammunition 260 from the firearm 200 otherwise being picked up, put down, exchanged, reloaded, or otherwise handled by the user 700. For example, the sensor device 950 may be configured to detect or be sensitive to a shock and/or acceleration of a particular minimum magnitude, which is above the threshold of normal handling of the firearm 200, but below the magnitude of the shock/vibration imparted by discharging of the ammunition 260, as a provision for filtering out noise. That is, the sensor device 950 is configured to be responsive to acceleration of the firearm 200 caused by the discharge of the ammunition 260 to generate the firearm discharge signal 1000, but the sensor device 950 is also configured to not generate the firearm discharge signal 1000 upon handling of the firearm 200 occurring (e.g., normal handling) without discharging the ammunition 260.

In some aspects, the transmitter device 900 may also be engaged with the glove (not shown), or is otherwise in communication with the sensor device 950 via a wired or wireless connection. In particular aspects, the transmitter device 900 and the sensor device 950 may be integrated or otherwise constructed as a single unit, as will be appreciated by one skilled in the art. In other particular aspects, the transmitter device 900 and the sensor device 950 are both associated with the user 700, or are both associated with the firearm 200, such that the firearm 200 remains untethered with respect to the user 700.

In some aspects, as disclosed herein, the unique indicium 300 associated with each of the firearm 200, ammunition 260, and/or magazine 280 is also configured to identify a position or an orientation of the firearm 200 or ammunition 260. In instances where a unique indicium 300 is associated with a user extremity, that unique indicium 300 may also indicate a position or an orientation of user extremity, independently or in relation to the firearm 200 or ammunition 260. That is, the unique indicia 300 associated with the firearm 200 and/or the user extremity may indicate, for example, whether the firearm 200 is being held in a firing position by the user 700 and/or the orientation/trajectory of the bore of the firearm 200 and/or whether the user extremity is engaged with the trigger mechanism 220. As such, the appropriately-identified firearm 200 may be displayed to the user 700 via the virtual reality headset 600 as a virtual simulation in relation to the virtual display of the user 700, as shown in FIG. 1.

Moreover, the controller device 550/computer device 500 may be configured to associate a virtual bullet (not shown) in the virtual simulation, scene, or space 800, associated with the firing of the blank cartridge (ammunition 260). Upon the user 700 (user extremity) pulling the trigger mechanism 220 for the firing mechanism 240 to fire the ammunition 260, the controller device 550/computer device 500 is configured and arranged to receive the tracking signal from the detection arrangement 400 and to make a discharge determination based thereon, or is configured and arranged to receive and respond to the firearm discharge signal 1000 received from the sensor device 950 via the transmitter device 900, to display on the virtual reality headset 600 a virtual simulation of the user 700 actuating the trigger mechanism 240 of the identified firearm 200. The controller device 550/computer device 500, in some instances, knowing the magnitude of the acceleration from the firearm 200 experienced by the user 700, or the magnitude of the tracked acceleration of the user extremity, upon discharge of the ammunition 260, may also virtually reflect the response of the user 700 to the discharge of the ammunition 260, as viewed by the user 700 via the virtual reality headset 600 (e.g., the user's reaction to the recoil of the firearm). Further, since the position, orientation, acceleration, rate of motion, and/or the like of the firearm 200 and/or the user extremity is known, along with characteristics of the ammunition 260, the controller device 550/computer device 500 may also be configured to respond to the tracking signal or the firearm discharge signal 1000 received from the sensor device 950, to display on the virtual reality headset 600 a trajectory of a virtual bullet launched from the discharged identified ammunition 260, as shown, for example, in FIG. 4, based at least on the position, orientation, acceleration, rate of motion, and/or the like of the identified firearm 200 and/or the user extremity as determined the controller device 550/computer device 500 from the tracking signal, or as determined by the detection arrangement 400 upon receipt by the controller device 550/computer device 500 of the firearm discharge signal 1000.

Associating a unique indicium 300 with the ammunition 260, as well as the magazine 280 and/or the user extremity, with all being detectable by the detection arrangement 400, also allows the controller device 550/computer device 500 to direct the virtual reality headset 600 to display a virtual simulation of the user 700 or user extremity handling the ammunition 260 and/or magazine 280, as the user 700 is loading, unloading, or reloading ammunition 260 with respect to the magazine 280 or the firearm 200, or engaging/disengaging the magazine with respect to the firearm 200. Moreover, the unique indicium 300 associated with the ammunition 260 may also allow the controller device 550/computer device 500 to direct the virtual reality headset 600 to display a virtual simulation of the firearm 200 ejecting the spent cartridges 270 (see, e.g., FIG. 3), once the ammunition 260 is fired.

Aspects of the present disclosure thus combine a sensor device such as an accelerometer with a transmitter, wherein the transmitter is configured to send a signal to a receiver incorporated into a virtual reality system for providing a virtual reality experience. A sensor/transmitter unit is affixed to each user/participant of a virtual reality-based weapons training exercise. One sensor/transmitter unit is affixed to the trigger hand of the user/trainee (for example, the unit could be integrated into a glove worn on the hand of the user/training participant) or to the firearm itself. The firearms and ammunition used by the user in the physical simulation are augmented with reflective markers, fiducial markers, or other identifying technologies that allow the virtual reality system to track their position, orientation, acceleration, rate of motion, and/or the like. As such, other aspects of the present disclosure can implement to the tracking function, based on unique indicia engaged with each tracked object, to track the position, orientation, acceleration, rate of motion, and/or the like of the firearm 200, ammunition 260, magazine 280, and/or the user extremity. The virtual reality simulation system can then display a virtual proxy for the real weapon(s) and ammunition as part of the simulated environment, and render it correctly from the perspective of the user and with respect to the user extremity engaging the weapon.

The ammunition used for the purposes of the physical simulation is blank cartridges. When the weapons are fired, the shock/vibration generated by the cartridge discharging is determined from the position, orientation, acceleration, rate of motion, and/or the like of the firearm 200, ammunition 260, magazine 280, and/or the user extremity, or detected by the sensor/transmitter, and can be distinguished from other motions/accelerations caused by picking up, aiming, or even dropping the weapon. In aspects where implemented, the sensor (e.g., accelerometer) data is streamed via wireless link to the computer generating the virtual simulated environment, where the data is analyzed by the simulation software. When distinct spikes in acceleration caused by weapon discharge are detected in the data, the virtual simulation system calculates and virtually renders the effects of firing the weapon currently being held by the user as detected by the detection arrangement, or assigned to the sensor which emitted the spike. The specific weapon being held by the user is determined by the weapon tracking system, via tracking marks affixed to the weapon and to the body of the simulation user. Because the physical weapon is firing real (blank) cartridges, it responds as it would in the real world in terms of sound, vibration, recoil, and cycle time. When the weapon is empty, the user/trainee must reload it from ammunition available as part of the physical simulation. Thus, the problem of unrealistic behavior and characteristics of weapon implements used in virtual reality-based weapons or combat training environments is solved.

Many modifications and other embodiments of the inventions set forth herein will come to mind to one skilled in the art to which these disclosed embodiments pertain having the benefit of the teachings presented in the foregoing descriptions and the associated drawings. Therefore, it is to be understood that embodiments of the invention are not to be limited to the specific embodiments disclosed and that modifications and other embodiments are intended to be included within the scope of the invention.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure. In this regard, for example, different combinations of elements and/or functions than those explicitly described above are also contemplated within the scope of the disclosure. Although specific terms are employed herein, they are used in a generic and descriptive sense only and not for purposes of limitation

It should be understood that although the terms first, second, etc. may be used herein to describe various steps or calculations, these steps or calculations should not be limited by these terms. These terms are only used to distinguish one operation or calculation from another. For example, a first calculation may be termed a second calculation, and, similarly, a second step may be termed a first step, without departing from the scope of this disclosure. As used herein, the term “and/or” and the “I” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

That which is claimed:

1. A firearm simulation arrangement for a virtual reality system, comprising:
a firearm having a trigger mechanism engaged with a firing mechanism configured to fire ammunition;
a unique indicium associated with each of the firearm, the ammunition, and a user extremity arranged to hold the firearm;
a detection arrangement configured to detect the unique indicia and to identify and track the firearm or the ammunition, to detect the unique indicium and track the user extremity independently of or in relation to the firearm or ammunition, and to form a tracking signal in response to the tracked unique indicia; and
a controller device engaged with the detection arrangement and being in communication with a virtual reality headset adapted to be worn by the user, the controller device being arranged to receive the tracking signal from the detection arrangement and determine therefrom a discharge of the ammunition by the firing mechanism associated with the tracking of the user extremity relative to the firearm or the ammunition, the controller device being responsive to the discharge determination to display on the virtual reality headset a virtual simulation of the identified firearm discharging the identified ammunition upon actuation of the trigger mechanism by the identified user extremity.

2. The arrangement of claim 1, wherein the ammunition comprises a blank cartridge.

3. The arrangement of claim 2, wherein the controller device is configured to associate a virtual bullet with the blank cartridge, and to display the virtual bullet in the virtual simulation on the virtual reality headset.

4. The arrangement of claim 1, wherein the unique indicium associated with each of the firearm and the ammunition is configured to identify a position or an orientation of the firearm or ammunition, and the unique indicium associated with the user extremity is arranged to identify a position or an orientation of the user extremity in relation to the position or the orientation of the firearm or ammunition.

5. The arrangement of claim 1, wherein the controller device is responsive to the discharge determination to display on the virtual reality headset a virtual simulation of the user actuating the trigger mechanism of the identified firearm.

6. The arrangement of claim 1, wherein the controller device is responsive to the discharge determination to display on the virtual reality headset a trajectory of a virtual bullet launched from the discharged identified ammunition, based at least on a position or orientation of the identified firearm upon the discharge determination.

7. A firearm simulation arrangement for a virtual reality system, comprising:
a firearm having a trigger mechanism engaged with a firing mechanism configured to fire ammunition, each of the firearm and the ammunition having a unique indicium associated therewith;
a detection arrangement configured to detect the unique indicia and identify the firearm and the ammunition;
a transmitter device configured to communicate with the detection arrangement;
a sensor device configured to be in communication with the transmitter device and being associated with a user holding the firearm, the sensor device being configured to be responsive to discharging of the ammunition by the firing mechanism, to direct a firearm discharge signal through the transmitter device to the detection arrangement; and
a controller device engaged with the detection arrangement and being in communication with a virtual reality headset adapted to be worn by the user, the controller device being responsive to the firearm discharge signal received from the sensor device to display on the virtual reality headset a virtual simulation of the identified firearm discharging the identified ammunition.

8. The arrangement of claim 7, wherein the sensor device is selected from the group consisting of an inertial sensor, a motion sensor, an accelerometer, a rotation sensor, a gyroscope, a magnetic sensor, a magnetometer, a microphone, or combinations thereof.

9. The arrangement of claim 7, wherein the ammunition comprises a blank cartridge.

10. The arrangement of claim 9, wherein the controller device is configured to associate a virtual bullet with the blank cartridge, and to display the virtual bullet in the virtual simulation on the virtual reality headset.

11. The arrangement of claim 7, wherein the sensor device is engaged with a glove adapted to be worn on a trigger hand of the user or with the firearm.

12. The arrangement of claim 11, wherein the transmitter device is engaged with the glove.

13. The arrangement of claim 7, wherein the unique indicium associated with each of the firearm and the ammunition is configured to identify a position or an orientation of the firearm or ammunition.

14. The arrangement of claim 7, wherein the sensor device is configured to be responsive to acceleration of the firearm caused by the discharge of the ammunition to generate the firearm discharge signal.

15. The arrangement of claim 14, wherein the sensor device is configured to not generate the firearm discharge signal upon handling of the firearm occurring without discharging the ammunition.

16. The arrangement of claim 7, wherein the controller device is responsive to the firearm discharge signal received from the sensor device to display on the virtual reality headset a virtual simulation of the user actuating the trigger mechanism of the identified firearm.

17. The arrangement of claim 7, wherein the controller device is responsive to the firearm discharge signal received from the sensor device to display on the virtual reality headset a trajectory of a virtual bullet launched from the discharged identified ammunition, based at least on a position or orientation of the identified firearm upon receipt of the firearm discharge signal.
